(19) United States
(12) Patent Application Publication
(10) Pub. No.: US 2008/0068548 A1
(43) Pub. Date: Mar. 20, 2008

(54) LIQUID CRYSTAL DISPLAY DEVICE

(76) Inventors: Ji-hyun Kwon, Chungcheongnam-do (KR); Won-hee Lee, Seoul (KR); Ho-kyoon Kwon, Seoul (KR); Byoung-sun Na, Gyeonggi-do (KR); Dong-hyeon Ki, Chungcheongnam-do (KR); Soon-il Ahn, Chungcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/855,451

(22) Filed: Sep. 14, 2007

(30) Foreign Application Priority Data
Sep. 15, 2006 (KR) 10-2006-0089477

(51) Int. Cl. G02F 1/1337; G02F 1/1343

(52) U.S. Cl. 349/139; 349/129

(57) ABSTRACT

A liquid crystal display device includes a first insulating substrate, a gate line and a data line which are formed on the first insulating substrate and intersect each other insulatedly to define a pixel area. A pixel electrode is electrically coupled to the data line and includes a first stem electrode which is parallel with the data line, a plurality of first branch electrodes which are connected with the first stem electrode and substantially parallel with each other, and a first edge electrode which is located at a connecting area between the first stem electrode and the first branch electrode and extends to an area between the first branch electrodes. A second insulating substrate is provided which includes a common electrode formed on the second insulating substrate, the common electrode including a plurality of second branch electrodes which are located between the first branch electrodes. The second branch electrodes are substantially parallel with the first branch electrodes. A second stem electrode connects the plurality of second branch electrodes, and a second edge electrode is located at a connecting area between the second branch electrode and the second stem electrode, and the second edge electrode extending in an area between the second branch electrodes. A liquid crystal layer is disposed between the first insulating substrate and the second insulating substrate.

### CROSS-REFERENCE TO RELATED APPLICATIONS

This application claims priority from Korean Patent Application No. 10-2006-0089477, filed on Sep. 15, 2006 in the Korean Intellectual Property Office, the disclosure of which is incorporated herein by reference.

### BACKGROUND OF INVENTION

1. Field of Invention

Apparatuses consistent with the present invention relate to a liquid crystal display device.

2. Description of the Related Art

A liquid crystal display device comprises a liquid crystal display (LCD) panel. The LCD panel comprises a first substrate having thin film transistors (TFT), a second substrate placed to correspond to the first substrate, and a liquid crystal layer disposed between the first substrate and the second substrate. Since the LCD panel does not emit light by itself, a backlight unit may be provided at the back side of the first substrate.

A pixel electrode is provided in the first substrate, and a common electrode is provided in the second substrate. The liquid crystal layer is disposed between the pixel electrode and the common electrode, and its arrangement is determined by an electric field which is produced between the pixel electrode and the common electrode.

Some liquid crystal display devices employ a structure in which the pixel electrode and the common electrode are patterned so that a pixel area can be divided into a plurality of sub-pixel areas. The pixel electrode and the common electrode are patterned to be separated from each other, and the electric field is produced by potential difference between the pixel electrode and the common electrode.

However, in the liquid crystal display devices employing such a structure, there exist some regions where electric field direction is non-uniform. If the electric field direction is non-uniform, the orientation of liquid crystal molecules cannot be properly controlled, which causes the overall aperture ratio to be lowered.

### SUMMARY OF THE INVENTION

Accordingly, it is an aspect of the present invention to provide a liquid crystal display device having improved aperture ratio.

Additional aspects of the present invention will be set forth in part in the description which follows and, in part, will be obvious from the description, or may be learned by practice of the present invention.

The foregoing and/or other aspects of the present invention can be achieved by providing a liquid crystal display device comprising: a first insulating substrate; a gate line and a data line which are formed on the first insulating substrate and intersect each other insulatedly to define a pixel area; a pixel electrode electrically connected with the gate line and the data line and comprising a first stem electrode which is parallel with the data line, a plurality of first branch electrodes which are connected with the first stem electrode and substantially parallel with each other, and a first edge electrode which is located at a connecting area between the first stem electrode and the first branch electrode and extends to an area between the first branch electrodes; a second insulating substrate; a common electrode formed on the second insulating substrate and comprising a plurality of second branch electrodes which are located between the first branch electrodes and disposed substantially parallel with the first branch electrodes, a second stem electrode which connects the plurality of second branch electrodes, and a second edge electrode which is located at a connecting area between the second branch electrode and the second stem electrode and extends to an area between the second branch electrodes; and a liquid crystal layer disposed between the first insulating substrate and the second insulating substrate.

According to an aspect of the invention, an angle between the first edge electrode and the first branch electrode is between 90 degrees and 135 degrees.

According to an aspect of the invention, the first edge electrode is formed at a part where the angle between the first branch electrode and the first stem electrode is an obtuse angle.

According to an aspect of the invention, an angle between the second edge electrode and the second branch electrode is between 90 degrees and 135 degrees.

According to an aspect of the invention, the second edge electrode is formed at a part where the angle between the second branch electrode and the second stem electrode is an obtuse angle.

According to an aspect of the invention, the pixel area comprises a plurality of sub-pixel areas which are surrounded by the pixel electrode and the common electrode, an angle between the pixel electrode and the common electrode surrounding each sub-pixel area is equal to or less than 90 degrees.

According to an aspect of the invention, the sub-pixel area has an elongated shape.

According to an aspect of the invention, an extending direction of the sub-pixel area is different from an extending direction of the gate line.

According to an aspect of the invention, the sub-pixel area has a shape of a quadrangle as a whole.

According to an aspect of the invention, the sub-pixel area is surrounded by the first branch electrode, the first edge electrode, the second branch electrode, and the second edge electrode.

According to an aspect of the invention, the sub-pixel area has a shape of a parallelogram.

According to an aspect of the invention, an angle between the first branch electrode and the second edge electrode is between 45 degrees and 90 degrees.

According to an aspect of the invention, the liquid crystal display device further comprises: a first alignment film formed on the pixel electrode and rubbed in a first direction; and a second alignment film formed on the common electrode and rubbed in a second direction, wherein the first direction and the second direction are antiparallel.

According to an aspect of the invention, the liquid crystal has a positive anisotropic dielectric constant, and an angle between an extending direction of the sub-pixel area and the first and second direction is between 0 degree and 45 degrees or between 135 degrees and 180 degrees.

According to an aspect of the invention, the first direction and the second direction are substantially parallel with an extending direction of the gate line.

According to an aspect of the invention, the liquid crystal has a negative anisotropic dielectric constant, and angle between an extending direction of the sub-pixel area and the first and second direction is between 45 degree and 90 degrees or between 90 degrees and 135 degrees.

According to an aspect of the invention, the first direction and the second direction are substantially parallel with the extending direction of the gate line.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is an enlarged plan view of a portion of a pixel area of a first substrate of a liquid crystal display device according to a first exemplary embodiment of the present invention.

FIG. 2 is an enlarged plan view of a common electrode of the liquid crystal display device according to the first exemplary embodiment of the present invention.

FIG. 3 is a sectional view taken along line III-III in FIG. 1.

FIG. 4 is an enlarged plan view showing the relative arrangement between a pixel electrode and a common electrode in the liquid crystal display device according to the first exemplary embodiment of the present invention.

FIG. 5 is a pictorial view diagram useful to illustrate how an aperture ratio is improved in the liquid crystal display device according to the first exemplary embodiment of the present invention.

FIG. 6A and FIG. 6B are diagrams to illustrate, along with the written description below, an alignment of a liquid crystal molecule in the liquid crystal display device according to the first exemplary embodiment of the present invention.

FIG. 7 is an enlarged plan view of a portion of a liquid crystal display device according to a second exemplary embodiment of the present invention.

FIG. 8A and FIG. 8B are diagrams to illustrate, along with the written description below, an alignment of a liquid crystal molecule in the liquid crystal display device according to the second exemplary embodiment of the present invention.

FIG. 9 is a pictorial view illustrating a liquid crystal display device according to a third exemplary embodiment of the present invention.

### DETAILED DESCRIPTION OF EXEMPLARY EMBODIMENTS OF THE INVENTION

Reference is made below in detail to the embodiments of the present invention, examples of which are illustrated in the accompanying drawings, wherein like reference numerals refer to like elements throughout. The embodiments described below explain the present invention by referring to the figures. Like elements may be representatively described in detail in a first exemplary embodiment of the present invention, thus may not be described in other exemplary embodiments.

In this specification, if “An angle is between A degrees and B degrees” is said, the “angle” does not include “A degrees” nor “B degrees”. For example, if it is said that the angle is between 0 degree and 45 degrees, the angle does not include 0 degree nor 45 degrees.

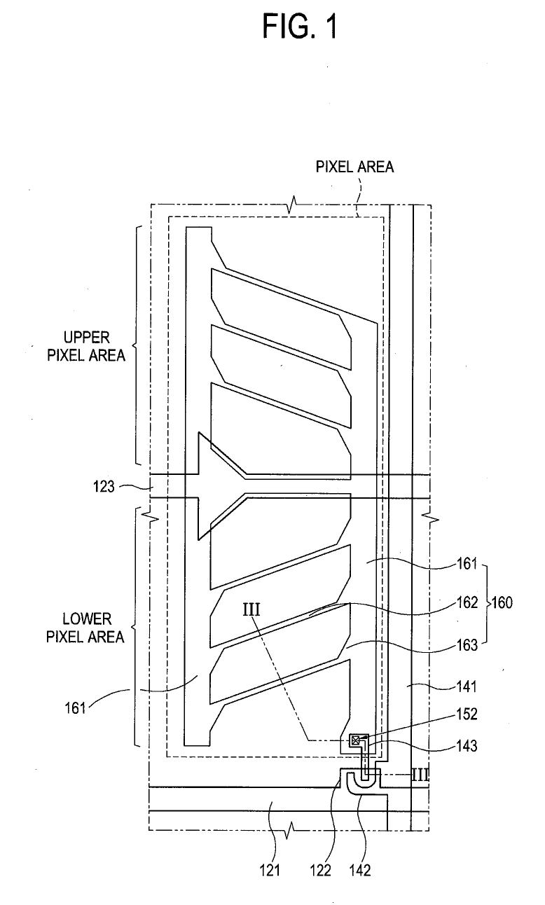

Hereinafter, a liquid crystal display device according to a first exemplary embodiment of the present invention is described with reference to FIG. 1 to FIG. 6.

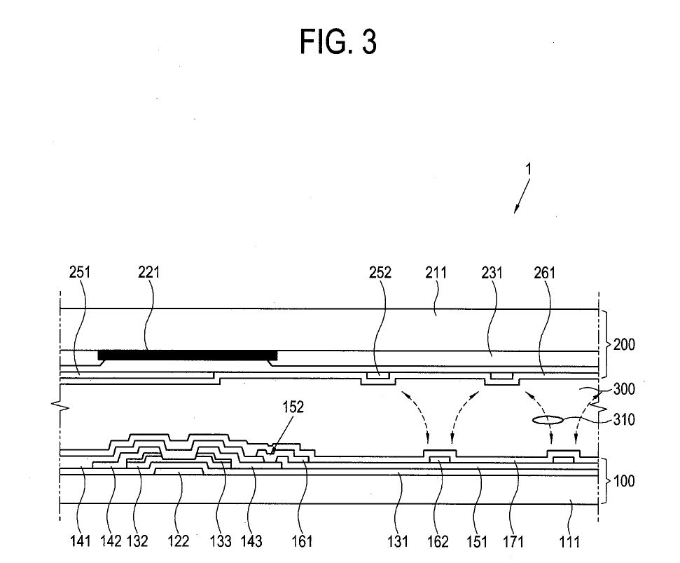

Firstly, referring to FIG. 3, a liquid crystal display device 1 comprises a first substrate 100 and a second substrate 200 both of which are placed to correspond to each other, and a liquid crystal layer 300 disposed between the substrates 100 and 200. In this embodiment, a liquid crystal molecule 310 of the liquid crystal layer 300 has a positive anisotropic dielectric constant. If an electric field is applied, the liquid crystal molecule 310 is aligned so that its major axis becomes parallel with the electric field.

The first substrate 100 is described with reference to FIG. 1 and FIG. 3.

Gate wirings 121, 122 and 123 are formed on a first insulating substrate 111. The gate wirings 121, 122 and 123 may be a single metal layer or a multiple metal layer. The gate wirings 121, 122 and 123 comprise a gate line 121 extending horizontally, a gate electrode 122 connected to the gate line 121, and a sustain electrode line 123 extending parallel with the gate line 121. The sustain electrode line 123 overlaps with a pixel electrode 160 to make a storage capacitor.

On the first insulating substrate 111, the gate wirings 121, 122 and 123 are covered by a gate dielectric film 131 which comprises silicon nitride (SiNx) and/or similar materials.

A semiconductor layer 132 comprising amorphous silicon and/or other semiconductor is formed on the gate dielectric film 131 of the gate electrode 122. An ohmic contact layer 133, which comprises silicide or n+ hydrogenated amorphous silicon heavily doped with n type impurities is formed on the semiconductor layer 132. The ohmic contact layer 133 is divided into two separated parts.

Data wirings 141, 142 and 143 are formed on the ohmic contact layer 133 and the gate dielectric film 131. The data wirings may also be a single layer or a multiple layer. The data wirings 141, 142 and 143 comprise a data line 141 extending vertically to intersect with the gate line 121, a source electrode 142 being a branch of the data line 141 and extending to an upper part of the ohmic contact layer 133, and a drain electrode 143 separated from the source electrode 142 and formed on the other separated ohmic contact layer 133.

A pixel area is an area surrounded by the gate line 121 and the data line 141, and has approximately a rectangular shape. The pixel area is divided by the sustain electrode line 123 into an upper pixel area and a lower pixel area.

A passivation film 151 is formed on the data wirings 141, 142 and 143 and on the semiconductor layer 132 which the data wirings 141, 142 and 143 do not cover. The passivation film 151 may comprise silicon nitride, a-Si:C:O or a-Si:O:F deposited by PECVD method, or coating acrylic organic insulator, and etc. The passivation film 151 has a contact hole 152 which exposes the drain electrode 143.

The pixel electrode 160 is formed on the passivation film 151. Generally, the pixel electrode 160 comprises a transparent conductor such as indium tin oxide (ITO), and indium zinc oxide (IZO).

The pixel electrode 160 comprises a pair of first stem electrodes 161 extending to be parallel with the data line, a first branch electrode 162 extended between the first stem electrodes 161 and interconnecting the first stem electrodes 161, and a first edge electrode 163 disposed at a connecting area between the first stem electrode 161 and the first branch electrode 162. The first branch electrode 162 extends not to be parallel with the gate line 121, and is approximately symmetrical with its axis of symmetry being the sustain electrode line 123.

The first edge electrode 163 extends to an area between the first branch electrodes 162 which are opposite to each other. The first edge electrode 163 is located at an area where the first stem electrode 161 meets the first branch electrode 162 with an obtuse angle.

The pixel electrode 160 is electrically connected with the drain electrode 143 through the contact hole 152.

A first alignment film 171 is formed on the pixel electrode 160.

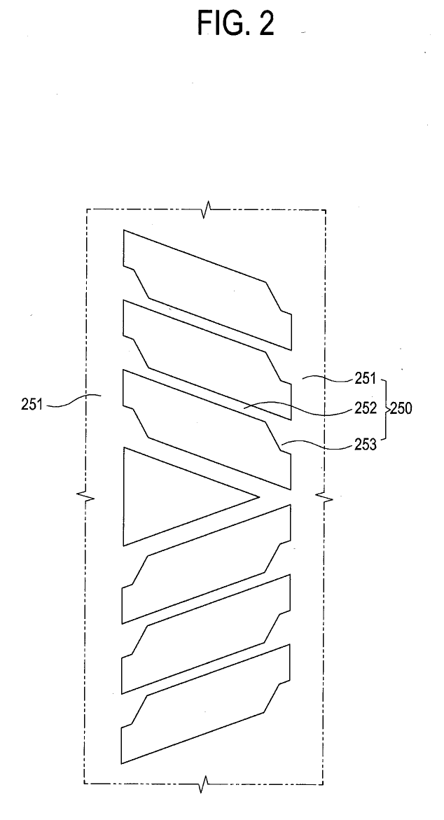

The second substrate 200 is described with reference to FIG. 2 and FIG. 3.

A black matrix 221 is formed on a second insulating substrate 211. Generally, the black matrix 221 separates red filter, green filter and blue filter, and prevents direct irradiation onto the semiconductor layer 132 which is located on the first substrate 100. Generally, the black matrix 221 comprises a photosensitive organic material which contains black pigment. The black pigment includes carbon black, titanium oxide or etc.

A color filter 231 has its boundary formed by the black matrix 221. The color filter 231 comprises three sub-layers (not shown) which represent red, green and blue colors respectively. The color filter 231 gives colors to the light which is irradiated from a backlight unit and passes through the liquid crystal layer 300. Generally, the color filter 231 comprises photosensitive organic material.

An over coat layer 241 is formed on the color filter 231 and the black matrix 221. The over coat layer 241 comprises organic material to provide a flat surface. The over coat layer 241 may be omitted.

A common electrode 250 is formed on the over coat layer 241. The common electrode 250 comprises transparent conductive material such as indium tin oxide (ITO) and indium zinc oxide (IZO). The common electrode 250, along with the pixel electrode 160 of the first substrate 100, applies voltage to the liquid crystal layer 300.

The common electrode 250 is patterned on a part corresponding to the pixel area. That is, the common electrode 250 is partially removed at the part which corresponds to the pixel area. The patterned common electrode 250 comprises a second stem electrode 251 surrounding the pixel area, a second branch electrode 252 traversing the pixel area and connecting the second stem electrode 251, and a second edge electrode 253 formed at a connecting area between the second stem electrode 251 and the second branch electrode 252. The second branch electrode 252 extends not to be parallel with the gate line 121 and is approximately symmetrical with its axis of symmetry being the sustain electrode line 123.

The second edge electrode 253 extends to an area between the second branch electrodes 252 which are opposite to each other. The second edge electrode 253 is located at an area where the second stem electrode 251 meets the second branch electrode 252 with an obtuse angle.

A second alignment film 261 is formed on the common electrode 250.

The first alignment film 171 and the second alignment film 262 are rubbed in a direction which is parallel with the gate line 121.

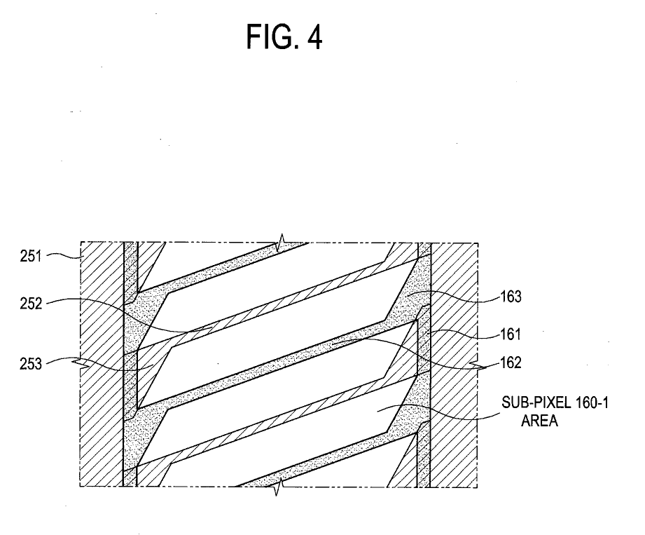

A relation in the disposition of the pixel electrode 160 and the common electrode 250 is described with reference to FIG. 4 which shows a part of the lower pixel area.

Referring to FIG. 4, the pixel area is divided into a plurality of sub-pixel areas 160-1 which are surrounded by the pixel electrode 160 and the common electrode 250 respectively. Each sub-pixel area 160-1 has the same size.

The sub-pixel area 160-1 has an elongated parallelogram shape. Two sides of the sub-pixel area 160-1 are surrounded by the pixel electrode 160, and the other two sides of the sub-pixel area 160-1 are surrounded by the common electrode 250. Specifically, the sub-pixel area 160-1 is surrounded by the first branch electrode 162 of the pixel electrode 160, the first edge electrode 163 of the pixel electrode 160, the second branch electrode 252 of the common electrode 250, and the second edge electrode 253 of the common electrode 250.

The first branch electrode 162 of the pixel electrode 160 and the second branch electrode 252 of the common electrode 250, which make long sides of the sub-pixel area 160-1, are placed to be parallel and opposite to each other. The first edge electrode 163 of the pixel electrode 160 and the second edge electrode 253 of the common electrode 250, which make short sides of the sub-pixel area 160-1, are placed to be parallel and opposite to each other.

As will be appreciated by the reference to FIG. 1, FIG. 2 and FIG. 4, the sub-pixel areas 160-1 in the upper pixel area and the sub-pixel areas 160-1 in the lower pixel area extend in different directions to each other.

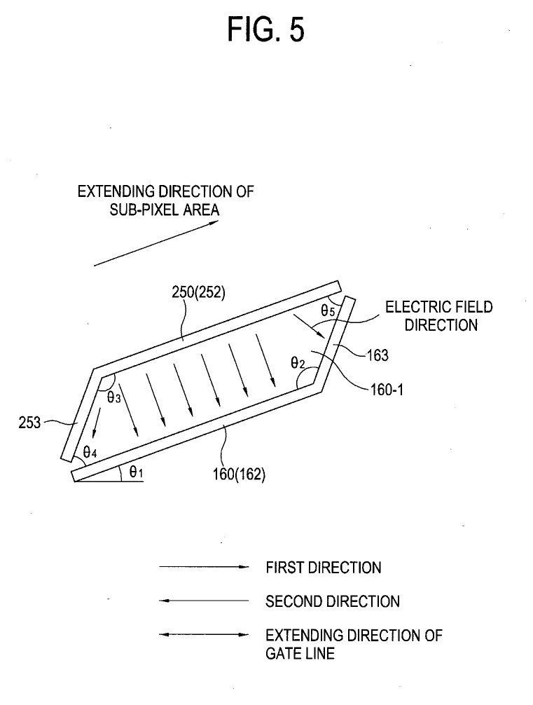

Hereinafter, why an aperture ratio is improved according to the first exemplary embodiment is explained with reference to FIG. 5. The sub-pixel area 160-1 and the pixel electrode 160 and the common electrode 250 which are surrounding the sub-pixel area 160-1 are pictorially illustrated in FIG. 5.

Referring to FIG. 5, an inclination angle θ1 between the first branch electrode 162 of the pixel electrode 160 and the extending direction of the gate line 121 is between 0 degree and 45 degrees. The second branch electrode 252 of the common electrode and the extending direction of the gate line 121 meet each other with the inclination angle θ1. Also, the extending direction of the pixel electrode and the extending direction of the gate line 121 meet each other with an inclination angle θ1.

The first alignment film 171 is rubbed in a first direction which is parallel with the gate line 121. The second alignment film 261 is rubbed in a second direction which is parallel with, but opposite to the first direction.

A bent angle θ2 of the pixel electrode 160 surrounding the sub-pixel area 160-1 is between 90 degrees and 135 degrees. A bent angle θ3 of the common electrode 250 surrounding the sub-pixel area 160-1 is the same as the bent angle θ2 of the pixel electrode 160.

An angle θ4 between the first branch electrode 162 of the pixel electrode 160 and the second edge electrode 253 of the common electrode 250 is between 45 degrees and 90 degrees. An angle θ5 between the first edge electrode 163 of the pixel electrode 160 and the second branch electrode 252 of the common electrode 250 is the same as θ4.

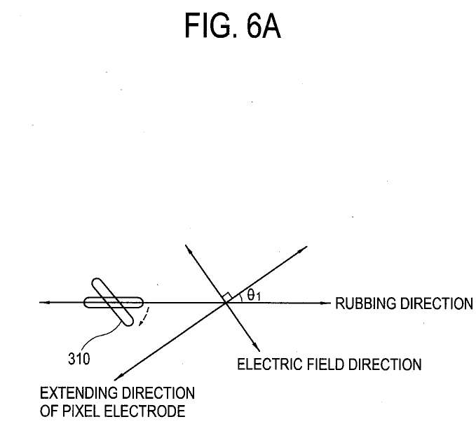

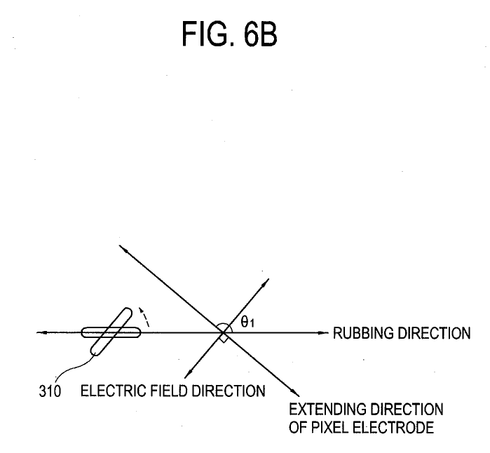

On the other hand, the inclination angle θ1 in FIG. 6B between the first branch electrode 162 of the pixel electrode 160 and the rubbing direction in the upper pixel area is between 135 degrees and 180 degrees. The sum of the inclination angle θ1 (see FIG. 6A) of the lower pixel area and the inclination angle θ1 (see FIG. 6B) of the upper pixel area may be 180 degrees.

If the voltage is not applied, the liquid crystal molecule 310 is aligned to be almost parallel with the insulating substrates 111 and 211. The major axis of the liquid crystal molecule 310 is aligned substantially parallel with the rubbing direction.

In case that the electric field is formed by the application of the voltage, the alignment of the liquid crystal molecule 310 is described with reference to FIG. 3, FIG. 6A and FIG. 6B. The alignment of the liquid crystal molecule 310 in a horizontal direction is described in FIG. 6A and FIG. 6B. FIG. 6A represents the lower pixel area, and FIG. 6B represents the upper pixel area.

If the voltage is applied, the electric field is formed between the pixel electrode 160 and the common electrode 250 as shown in FIG. 3. Especially, the electric field is formed between the first branch electrode 162 of the pixel electrode 160 and the second branch electrode 252 of the common electrode 250, which extend to be opposite to each other. Since the pixel electrode 160 and the common electrode 250 are vertically separated by the liquid crystal layer 300, the electric field has both horizontal electric field and vertical electric field components. However, as the horizontal electric field is dominant, the liquid crystal molecule rotates mostly in a plane which is parallel with the insulating substrates 111 and 211 to adjust light transmittance rate.

As shown in FIG. 6A and FIG. 6B, the horizontal electric field is formed to be vertical to the extending direction of the sub-pixel area 160-1, and the major axis of the liquid crystal molecule 310 is aligned to be parallel with the electric field. Since the angles θ4 and θ5 between the pixel electrode 160 and the common electrode 250 are acute angles, the electric field is formed substantially in the same direction. Therefore, most liquid crystal molecules 310 in the sub-pixel area 160-1 are aligned in the same direction, so that the aperture ratio can be improved. That is, most of the liquid crystal layer 300 located in the sub-pixel area 160-1 is aligned in the same direction.

On the other hand, as shown in FIG. 6A and FIG. 6B, the inclination angle θ1 of the upper pixel area is different from that of the lower pixel area. Accordingly, a rotation direction of the molecule 310 in the upper pixel area is different from that of the molecule 310 in the lower pixel area, thus forming two domains. One pixel area is divided into two domains to improve visibility.

Alternatively, the angles θ4 and θ5 between the pixel electrode 160 and the common electrode 250 may be right angles. In this case, the sub-pixel area 160-1 may have an elongated rectangular shape, and the bent angle θ2 of the pixel electrode 160 and the bent angle θ3 of the common electrode 150 become right angles.

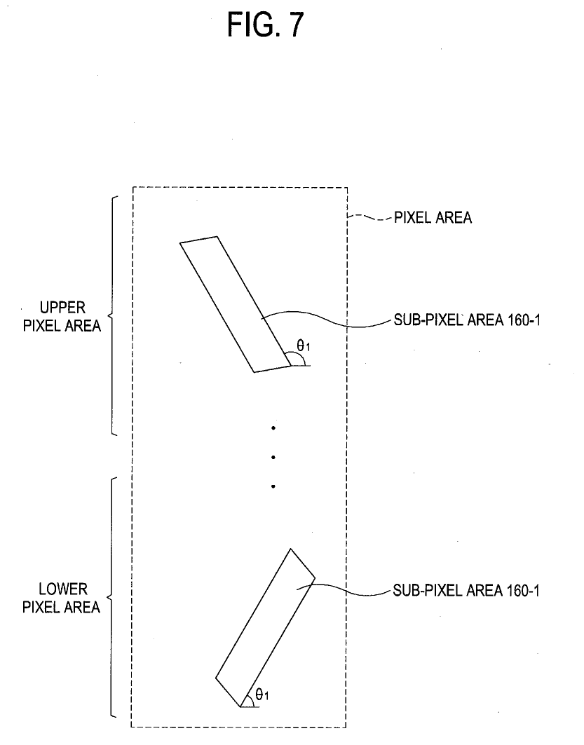

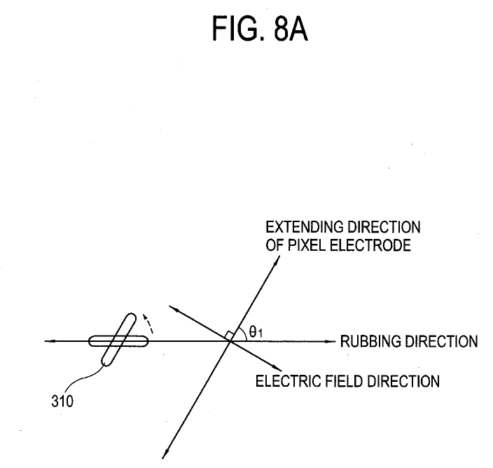

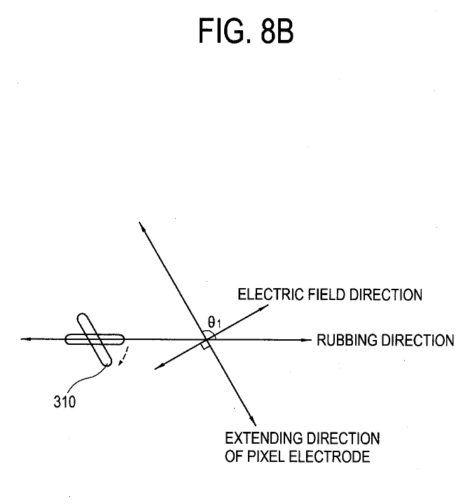

In the above first exemplary embodiment, the liquid crystal molecule 310 of the liquid crystal layer 300 has a positive anisotropic dielectric constant. However, the liquid crystal molecule 310 of the liquid crystal layer 300 may have a negative anisotropic dielectric constant, which is explained hereinafter with reference to FIG. 7, FIG. 8A and FIG. 8B. The alignment of the liquid crystal molecule 310 in a horizontal direction is described in FIG. 8A and FIG. 8B.

Referring to FIG. 7, the pixel area comprises a plurality of sub-pixel areas 160-1 disposed symmetrically by the upper pixel area and the lower pixel area. FIG. 7 is simplified and accordingly does not show the detail of prior figures, however the same terminology, such as branch electrode for example, is equally applicable.

In the lower pixel area, the inclination angle θ1 between the first branch electrode 162 of the pixel electrode 160 and the gate line 121 is between 45 degrees and 90 degrees. In the upper pixel area, the inclination angle θ1 is between 90 degrees and 135 degrees. The sum of the inclination angle θ1 of the lower pixel area and the inclination angle θ1 of the upper pixel area may be 180 degrees.

Referring to FIG. 8A and FIG. 8B, if the electric field is formed by the application of the voltage, the horizontal electric field is formed to be vertical to the extending direction of the sub-pixel area 160-1, and the minor axis of the liquid crystal molecule 310 is aligned to be parallel with the electric field. FIG. 8A represents the lower pixel area, and FIG. 8B represents the upper pixel area.

The inclination angle θ1 of the upper pixel area is different from the inclination angle θ1 of the lower pixel area. Accordingly, a rotation direction of the molecule 310 in the upper pixel area is different from that of the molecule 310 in the lower pixel area, thus forming two domains. One pixel area is divided into two domains to improve visibility.

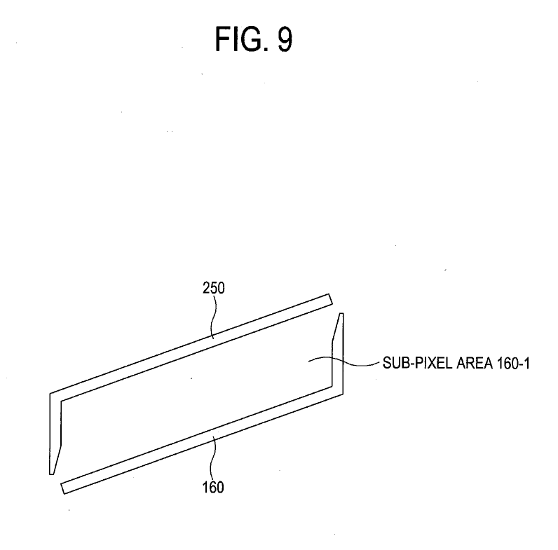

A third exemplary embodiment of the present invention is explained with reference to FIG. 9. One sub-pixel area 160-1 and the pixel electrode 160 and the common electrode 250 which are surrounding the sub-pixel area 160-1 are described in FIG. 9.

In the third exemplary embodiment, the sub-pixel area 160-1 has an elongated shape thus as a whole a parallelogram. However, both end parts of the sub-pixel area 160-1 along its extending direction do not have perfectly straight lines.

As described above, according to the present invention, a liquid crystal display device having improved aperture ratio can be provided.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display device comprising:
a first insulating substrate;
a gate line and a data line formed on the first insulating substrate and intersecting each other insulatedly to define a pixel area;
a pixel electrode selectively electrically coupled to the data line, the pixel electrode comprising a first stem electrode extending in a direction which is parallel with the data line, a plurality of first branch electrodes which are connected with the first stem electrode and substantially parallel with each other, and a plurality of first edge electrodes, one for each junction between the first branch electrodes and the first stem electrode, the first edge electrodes having an area which extends for a distance between the first stem electrode and the associated first branch electrode;
a second insulating substrate;
a common electrode formed on the second insulating substrate, the common electrode comprising a plurality of second branch electrodes which are located between the first branch electrodes, the second branch electrodes being disposed substantially parallel with the first branch electrodes, a second stem electrode which connects the plurality of second branch electrodes, and a plurality of second edge electrodes, one for each junction between the second branch electrodes and the second stem electrodes, the second edge electrodes having an area which extends for a distance between the second stem electrode and the associated second branch electrode; and
a liquid crystal layer disposed between the first insulating substrate and the second insulating substrate.

2. The liquid crystal display device according to claim 1, wherein an angle between the first edge electrode and the first branch electrode is between 90 degrees and 135 degrees.

3. The liquid crystal display device according to claim 2, wherein the first edge electrode is formed at a part where the angle between the first branch electrode and the first stem electrode is an obtuse angle.

4. The liquid crystal display device according to claim 1, wherein an angle between the second edge electrode and the second branch electrode is between 90 degrees and 135 degrees.

5. The liquid crystal display device according to claim 4, wherein the second edge electrode is formed at a part where the angle between the second branch electrode and the second stem electrode is an obtuse angle.

6. The liquid crystal display device according to the claim 1, wherein the pixel area comprises a plurality of sub-pixel areas which are surrounded by the pixel electrode and the common electrode, and further wherein an angle between the pixel electrode and the common electrode surrounding each sub-pixel area is equal to or less than 90 degrees.

7. The liquid crystal display device according to claim 6, wherein the sub-pixel area has an elongated shape.

8. The liquid crystal display device according to claim 7, wherein an extending direction of the sub-pixel area is different from an extending direction of the gate line.

9. The liquid crystal display device according to claim 7, wherein the sub-pixel area has a shape of a quadrangle.

10. The liquid crystal display device according to claim 9, wherein the sub-pixel area is surrounded by the first branch electrode, the first edge electrode, the second branch electrode, and the second edge electrode.

11. The liquid crystal display device according to claim 10, wherein the sub-pixel area has a shape of a parallelogram.

12. The liquid crystal display device according to claim 11, wherein an angle between the first branch electrode and the second edge electrode is between 45 degrees and 90 degrees.

13. The liquid crystal display device according to claim 7, further comprising:
a first alignment film formed on the pixel electrode, the first alignment film having been rubbed in a first direction; and
a second alignment film formed on the common electrode, the second alignment film having been rubbed in a second direction,
wherein the first direction and the second direction are antiparallel.

14. The liquid crystal display device according to claim 13, wherein the liquid crystal has a positive anisotropic dielectric constant, and an angle between an extending direction of the sub-pixel area and the first and second direction is between 0 degree and 45 degrees or between 135 degrees and 180 degrees.

15. The liquid crystal display device according to claim 14, wherein the first direction and the second direction are substantially parallel with an extending direction of the gate line.

16. The liquid crystal display device according to claim 13, wherein the liquid crystal has a negative anisotropic dielectric constant, and angle between an extending direction of the sub-pixel area and the first and second direction is between 45 degree and 90 degrees or between 90 degrees and 135 degrees.

17. The liquid crystal display device according to claim 16, wherein the first direction and the second direction are substantially parallel with the extending direction of the gate line.
